(19) United States
(12) Patent Application Publication
(10) Pub. No.: US 2009/0121073 A1
(43) Pub. Date: May 14, 2009

(54) Aircraft having a jet engine, an adjustable aft nozzle, and an electric vertical fan

(75) Inventors: Paul M. Doane, Manchester, MO (US); Thomas W. Omohundro, St. Charles, MO (US)

Correspondence Address: LEE & HAYES, PLLC, 601 W. RIVERSIDE AVENUE, SUITE 1400, SPOKANE, WA, 99201, US

(73) Assignee: The Boeing Company

(21) Appl. No.: 11/396,969

(22) Filed: Apr. 3, 2006

(51) Int. Cl. B64C 29/00; B64C 1/14

(52) U.S. Cl. 244/12.5; 244/129.4

(57) ABSTRACT

An adjustable nozzle is mounted on the airframe downstream from the powerplant for selectively directing powerplant exhaust to exit the aircraft at an angle between about rearward and downward. An electricity source mounted on the airframe powers a magnetically driven fan positioned in front of the powerplant in the fuselage.

### BACKGROUND OF THE INVENTION

The present invention relates to aircraft capable of vertical flight and, more particularly, to aircraft capable of vertical flight having a jet engine, an adjustable aft nozzle, and an electric vertical fan.

Aircraft capable of taking off and landing vertically or using short runways must provide balanced vertical thrust with respect to a center of gravity of the aircraft. Balanced thrust in a longitudinal direction with respect to the center of gravity can be accomplished by providing vertical thrust at about the center of gravity and/or providing generally the same amount of vertical thrust in front of and behind of the center of gravity. However, for fixed-wing jet aircraft, providing vertical thrust at and/or generally equally in front of and behind of the center of gravity is challenging for many reasons.

Fixed-wing aircraft include a main jet engine for providing thrust for forward flight. The main jet engine of fixed-wing jet aircraft is generally best positioned adjacent or in an aft end of the aircraft. Benefits of positioning the main jet engine adjacent or in the aft end of the aircraft include counterbalancing the weight of forward aircraft elements such as a cockpit, fuel tanks, and radar system components. Positioning the engine adjacent or in the aft end of the aircraft also minimizes the maximum cross-sectional area of the aircraft, which reduces drag. In comparison, aircraft having their main jet engine positioned farther forward in the fuselage are generally broader (e.g., wider and taller) to accommodate the engine and associated elements such as fuel tanks. Narrower fuselages have better drag characteristics, especially as the aircraft approaches or travels at sonic speeds.

Another detriment of positioning the engine too far forward of the aft end of the aircraft is that hot exhaust from the engine heats the exterior of the aircraft after leaving the engine unless it is ducted to the aft end for discharge, in which case the surface of the aircraft is undesirably heated. A heated aircraft surface may cause damage and provides a greater infrared signature, which undesirably increases susceptibility of the aircraft to detection. A further detriment of positioning the engine too far forward on the aircraft is short air intakes. When the engine is positioned closer to the front of the aircraft, a distance between an air inlet positioned in front of the engine is shorter than if the engine was positioned adjacent or in the aft end of the fuselage. For engine operation, air must be slowed from a speed at which it enters the air inlets to a requisite speed for entering the engine. A shorter air intake results in rapid slowing of the air between the inlet and the engine. Slowing air between the inlet and engine too quickly causes pressure losses, which lower thrust and may cause engine stall, and causes unwanted air separation, which further lowers thrust.

Aircraft designed for providing vertical lift having a main jet engine adjacent or in the aft end of the fuselage and providing vertical thrust in front of the center of gravity have numerous drawbacks. In one vertical flight design, the forward vertical thrust is provided by an additional jet engine positioned in front of the center of the gravity. Drawbacks of aircraft having this design include increased cost, weight, and volume of the additional engine, which is only used briefly during a typical flight. Further, hot engine exhaust directed downward from a forward jet engine may cause thermal damage to surfaces from which the aircraft operates. In addition, hot exhaust from the additional engine may be ingested into the air intake of the main engine, resulting in possible main engine stall or a significant loss of thrust from the main engine.

Another vertical flight aircraft having a main jet engine adjacent or in the aft end of the fuselage provides vertical thrust in front of the center of gravity by ducting air from the main engine to a port in a bottom surface of the aircraft forward of the center of gravity. The ductwork adds considerable weight to the aircraft and the aircraft must generally be larger to accommodate the substantial ductwork required to direct the main engine exhaust to the forward port. Further, if the ductwork becomes damaged, the forward port may loose tremendous efficiency or be inoperable and thereby inhibit vertical flight. Also, hot engine exhaust directed downward through the forward port may cause thermal damage to surfaces the aircraft operates from and may be ingested into the air intake of the main engine, resulting in possible engine stall or significant loss of thrust.

In yet another vertical flight aircraft having a main jet engine adjacent or in the aft end of the fuselage and providing vertical thrust in front of the center of gravity, the main engine is connected to a vertical fan forward of the center of gravity by a mechanical driveshaft. Drawbacks of this design include increased weight, required maintenance, and likelihood of breakage. Aircraft according to this design include a heavy and bulky clutch connected to the fan and to a heavy and bulky driveshaft for selectively operating the fan. Further, the large and heavy clutch and driveshaft generally require more maintenance than other components. Also, the clutch usually must be distanced far from the engine due to space limitations on the aircraft. As a result, the long and heavy driveshaft must spin continuously at the same speed as the engine during aircraft operation, even when the fan is not being used. In addition, if the clutch or driveshaft become damaged, the vertical fan will be inoperable, thereby inhibiting vertical flight.

### BRIEF SUMMARY OF THE INVENTION

The present invention relates to aircraft including an airframe having a fuselage extending between a forward end and an aft end. The aircraft further includes a power plant mounted on the airframe adjacent the aft end of the fuselage producing exhaust during operation thereof. The aircraft also includes an adjustable nozzle mounted on the airframe downstream from the power plant for selectively directing the power plant exhaust to exit the aircraft at a preselected angle with respect to the airframe within a range of angles extending from about horizontally rearward to about vertically downward. In addition, the aircraft includes an electricity source mounted on the airframe and connected to a delivery system and a fan positioned in the fuselage in front of the power plant. The fan includes a hub rotatably connected to the airframe and a plurality of blades extending radially outward from bases adjacent the hub to tips. The fan further includes a plurality of magnets positioned adjacent the blade tips and a housing attached to the airframe around the blades having a bottom and a top. In addition, the fan includes electric wires mounted on the housing and operatively connected to the delivery system for receiving an electric current from the electricity source during operation of the fan. The hub and the blades rotate when the magnets are attracted and/or repelled by the electric current moving through the wires to pull air through the fan for creating thrust during operation of the aircraft.

In another aspect, the present invention relates to aircraft including an airframe having a fuselage extending between a forward end and an aft end. The aircraft further includes a power plant mounted on the airframe producing exhaust during operation thereof. The aircraft also includes an adjustable nozzle mounted on the airframe downstream from the power plant for selectively directing the power plant exhaust to exit the aircraft at a preselected angle with respect to the airframe within a range of angles extending from about horizontally rearward to about vertically downward. In addition, the aircraft includes a source of electricity mounted on the airframe and a vertical fan positioned in the fuselage in front of the power plant and connected to the electricity source for providing vertical thrust during operation of the fan. The aircraft has a center of gravity and the power plant and the nozzle are positioned behind the center of gravity and the fan is positioned in front of the center of gravity.

In yet another aspect, the present invention relates to a method of flying an aircraft. The aircraft includes an airframe, a power plant mounted on the airframe, an electricity source mounted on the airframe, and a vertical fan mounted on the airframe in electric communication with the electricity source. The method includes directing high-pressure exhaust produced by the power plant to exit the aircraft at an angle between about horizontally rearward and about vertically downward. The method further includes selectively operating the fan using an electric current from the source of electricity to provide upward thrust.

Other aspects of the present invention will be in part apparent and in part pointed out hereinafter.

### BRIEF DESCRIPTION OF THE DRAWINGS

FIG. 1 is a perspective of an aircraft according to the present invention.

FIG. 2 is an enlarged view of the aircraft according to the present invention.

FIG. 3 is a cross section taken along line 3-3 of FIG. 1 showing the fan.

FIG. 4 is a cross section taken along line 4-4 of FIG. 3 showing an alternate embodiment of the fan.

FIG. 5 is an enlarged view of the cross section of FIG. 3.

Corresponding reference characters indicate corresponding parts throughout the several views of the drawings.

### DETAILED DESCRIPTION OF THE INVENTION

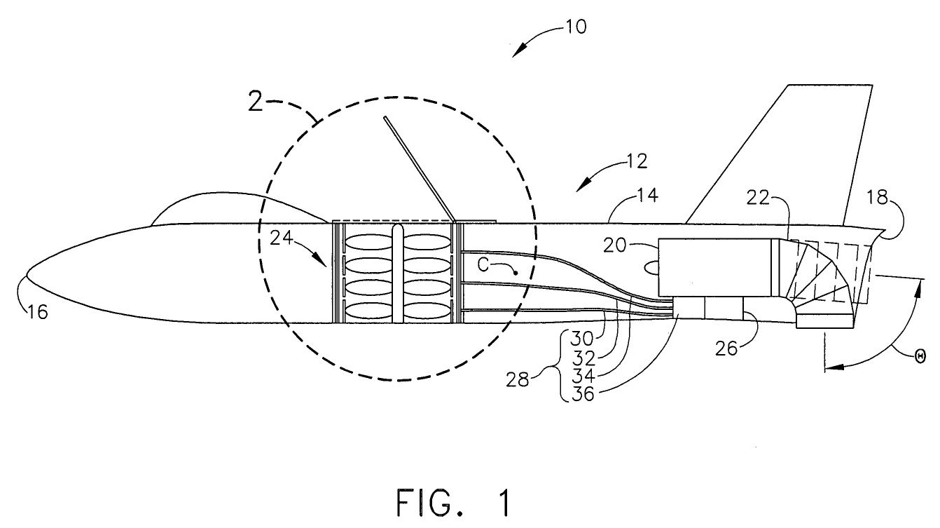

Referring to the drawings, and more particularly to FIG. 1, aircraft according to a first embodiment of the present invention is designated in its entirety by reference number 10. The aircraft 10 has an airframe 12 including a fuselage 14 having a forward end 16 and an aft end 18. Although the fuselage 14 may have other lengths without departing from the scope of the present invention, in one embodiment the fuselage has a length extending between the forward end 16 and the aft end 18 of between about 50 feet and about 80 feet. In another embodiment, the fuselage 14 is smaller, having a length between about 5 feet and about 50 feet. The aircraft 12 further includes at least two fixed wings (not shown) extending laterally from the fuselage 14. The wings may be rotatably connected to the fuselage. The aircraft 10 further includes a power plant 20 such as a jet engine mounted on the airframe 12. In one embodiment, the power plant 20 is mounted on the airframe 12 behind of a center of gravity “C” of the aircraft 10 and adjacent or in the aft end 18 of the fuselage 14. The power plant 20 produces hot high-pressure gas or exhaust during its operation. The power plant 20 exhaust is directed out of the aircraft to produce thrust. Although the power plant 20 may produce other amounts of thrust, in one embodiment the power plant produces between about 11,000 pounds and about 13,000 pounds of thrust. In another embodiment, the power plant may produce a lower amount of thrust, such as between about 100 pounds and about 11,000 pounds of thrust.

The aircraft 10 also includes a nozzle 22 mounted on the airframe 12 behind the center of gravity “C” and adjacent or in the aft end 18 of the fuselage 14 in fluid communication with the power plant 20 for receiving exhaust therefrom. The nozzle 22 is adjustable between multiple positions to provide thrust in various directions. For example, in one embodiment the nozzle 22 may selectively direct exhaust to exit the aircraft 10 at a preselected angle θ with respect to the airframe 12 within a range of angles extending from about vertically downward (i.e., θ=about 90°), as shown in FIG. 1 by solid lines, and about horizontally rearward (i.e., θ=about 0°), as shown by dashed lines. When the nozzle 22 is angled rearward, the exhaust exiting the aircraft 10 provides horizontal thrust, when the nozzle is angled downward the exhaust provides vertical thrust, and when the nozzle is angled between rearward and downward, the exiting exhaust provides thrust between rearward and downward according to the particular position of the nozzle.

The aircraft 10 includes an electric vertical fan 24 positioned in the fuselage 14 in front of the center of gravity “C” and the power plant 20 for providing vertical thrust. The vertical fan 24 is operatively connected to an electricity source 26 mounted on the airframe 12 by way of a delivery system 28. Although the electricity source 26 may be other types without departing from the scope of the present invention, in one embodiment the electricity source is an electric generator operatively connected to the power plant 20 for generating electric current such as an alternating current during operation of the aircraft 10. The delivery system 28 connecting the electricity source 26 to the vertical fan 24 may include multiple routes or paths 30, 32, 34. Although the aircraft 10 may have other number of paths without departing from the scope of the present invention, in one embodiment the aircraft has three paths including a first path 30, a second path 32, and a third path 34.

The electric delivery system 28 of the aircraft 10 may also include one or more switches or circuit breakers 36 for determining which path 30, 32, 34 the current flows through and for regulating the level of electrical flow. In one embodiment, each path 30, 32, 34 is an alternate path through which the electric current can flow from the electricity source 26 to the fan 24. For example, for initial operation of the vertical fan 24, the switch 36 may first be set so the current flows through all of the multiple paths 30, 32, 34. Then, if the first path 30 became inoperable, the switch 36 could change to send the electricity to the vertical fan 24 by way of the two remaining paths 32, 34 or a single path 34 of the multiple paths 30, 32, 34. The aircraft 10 is more reliable for vertical flight when the electric current can flow through multiple alternate paths 30, 32, 34. In comparison, vertical flight capabilities of the conventional drive shaft design and hot exhaust ducting design described above in the Background of the Invention section fully relies on the integrity of a single path for power delivery (i.e., the drive shaft or the exhaust ductwork).

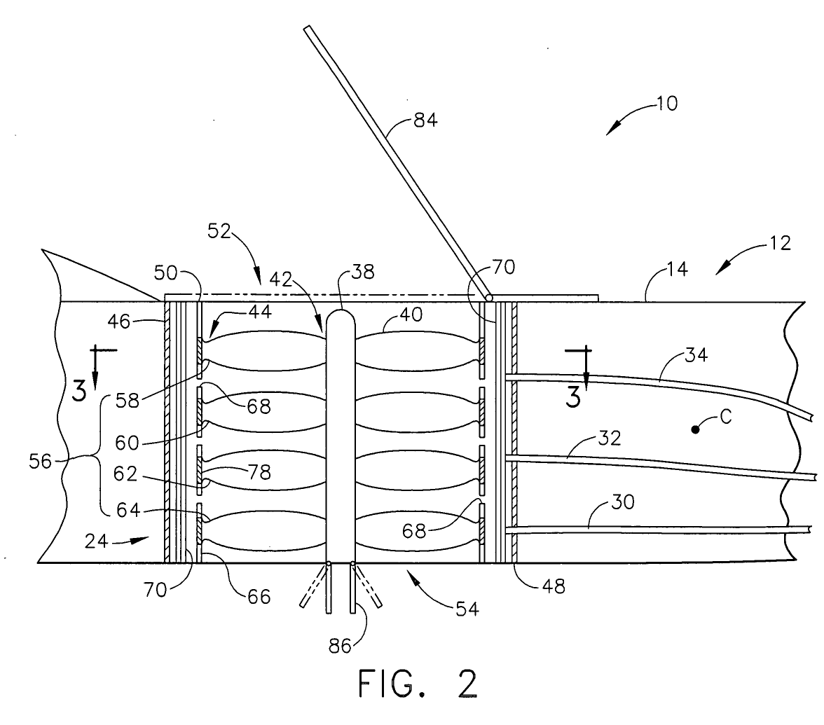

As shown in FIG. 2, the fan 24 may include a hub 38 rotatably connected to the airframe 12. The fan 24 also includes a plurality of blades 40 extending radially outward from bases 42 adjacent the hub 38 to tips 44 opposite the bases. In addition, the fan 24 includes a housing 46 attached to the airframe 12 around the blades 40 having a bottom 48 and a top 50. The blades 40 compress air entering a top 52 of the fan 24 and direct the air to exit the fan from a bottom 54 of the fan to provide upward thrust. The blades 40 may be arranged on the hub 38 in sections or stages 56. Although the fan 24 may include other number of stages 56 without departing from the scope of the present invention, in one embodiment, the fan includes four stages 58, 60, 62, 64. In one embodiment, the fan 24 preferably has an even number of stages 56, such as two, four, or six stages. The fan 24 stages 56 may be counter-rotating. In other words, each set of adjacent blade stages 58/60, 60/62, 62/64 may rotate in opposite directions. For example, a first stage 58 and a third stage 62 of the stages 56 may rotate clockwise, when viewed from above, while a second stage 60 and a fourth stage 64 rotate counter-clockwise. Counter-rotating fan blade stages 56 have many benefits. For example, the counter-rotating stages 56 cause the air passing through the fan to change direction more, which increases air compression within the fan, thereby improving fan performance. Counter-rotating stages 56 also cancel gyroscopic moments created by each stage.

As shown in FIG. 2, the fan 24 may also include a shroud 66 extending between the tips 44 of each set of adjacent blades 40 in each stage 56. In fan designs lacking a shroud, thrust losses result from air traveling between the blade tips 44 and the housing 46. The shroud 66 minimizes such thrust loses by ensuring air does not travel between the blade tips 44 and the housing 46. The shroud 66 also improves structural rigidity of the fan 24. In embodiments having multiple counter-rotating blade stages, separate components of the shroud 66 must be separated by discontinuities 68. Adjacent shroud 66 components may be sealed together at the discontinuities 68 to limit air passing through the fan 24 passing between the components and to the housing 46.

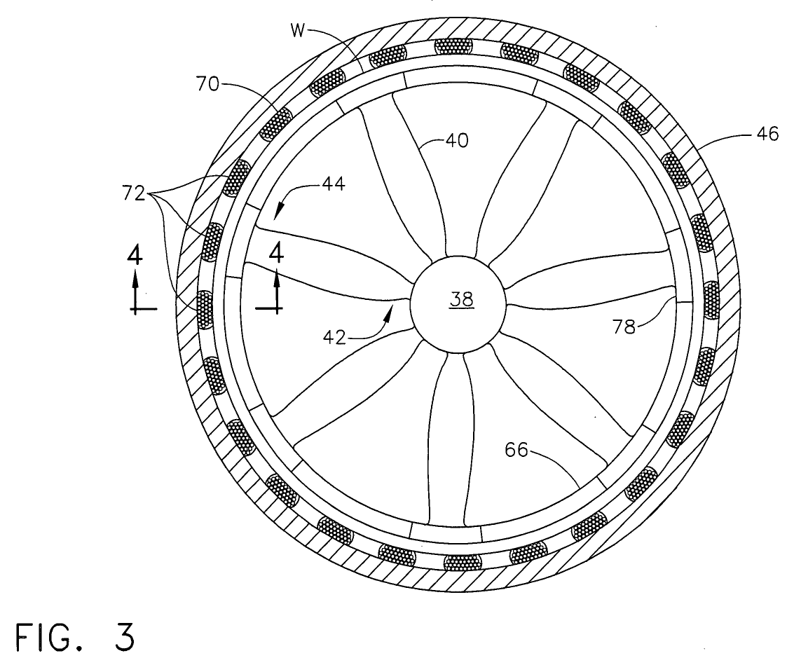

The fan 24 may be driven in various ways without departing from the scope of the present invention. In one embodiment (not shown), the fan is driven by an electric motor that turns the hub 38 by way of a drive belt. In a particular embodiment, a motor is integrated into the hub 38 for driving the fan 24. The fan 24 may also be driven by other motor types, such as an induction motor or a switched-reluctance motor. In the embodiment shown in the figures, an electric motor is be formed as an integral part of the fan 24. Particularly, the fan 24 includes electric wires 70 mounted on or embedded in the housing 46. In one embodiment, the housing 46 includes a wall “W” (shown in FIG. 3) between the electric wires 70 and the blades 40. The housing 46 remains stationary with respect to the airframe 12 during fan 24 operation and, when the electric wires 70 are mounted thereon, is analogous to a stator of traditional electric motors. The electric wires 70 are operatively connected to the delivery system 28 for receiving electric current from the electricity source 26. Each current carrying wire 70 creates an electromagnetic field corresponding in polarity and strength to a direction and a strength of the current.

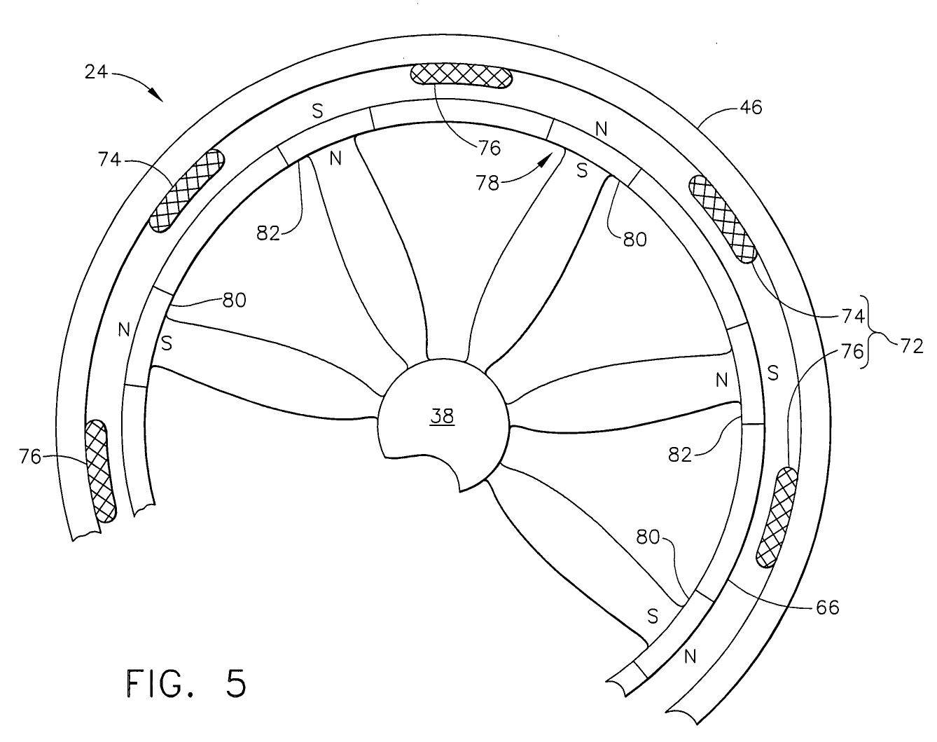

As shown in FIG. 3, the electric wires 70 may be arranged into one or more current channels 72 (shown in FIG. 3) for carrying the current from the electricity source 26. The channel 72 may include a single wire or cable 70 or a bundle of wires. The channel 72 may be arranged in a winding around the housing 46. For example, in one embodiment, the channel 72 extends upward on the housing in a portion, then turns adjacent the top 50 of the housing, extends downward on the housing, turns adjacent the bottom 48 of the housing, then extends upward again on the housing, and so on. In this configuration, adjacent vertical portions 74, 76 (shown in FIG. 5) of the channel will produce electromagnetic fields having opposite polarity.

For embodiments of the fan 24 having multiple counter-rotating blade stages 56 as described above, adjacent blade stages 58/60, 60/62, 62/64, may be driven in opposite directions in various ways. In one embodiment, every other blade stage 58/62 or 60/64 is driven by electromagnetic fields produced by the electrical channels 72 and the blade stages 60/64 or 58/62 between the driven blade stages are connected to the driven blade stages by gears (not shown in detail) so these intermediate blade stages 60/64 or 58/62 rotate in a direction opposite from a rotation direction of the driven blade stages. As will be appreciated by those skilled in the art, various types of gearing and other transmissions may connect adjacent blade stages 58/60, 60/62, 62/64 in various ways without departing from the scope of the present invention. For example, bevel gears may connect adjacent blade stages in or adjacent the hub 38 and/or between the shrouds 66.

As described above, in embodiments where adjacent blade stages 58/60, 60/62, 62/64 are connected to respective shrouds 66, the shrouds of adjacent stages must be separated. In a particular embodiment (not shown in detail), the shrouds 66 connected to every other blade stage 58/62 or 60/64 are connected to each other. A connection between shrouds 66 may provide various benefits. For example, shrouds 66 connecting every other blade stage 58/62 or 60/64 can ensure that those stages rotate in sync. The shrouds 66 may be connected so they form a single shroud extending from adjacent the top 52 of the fan 24 to adjacent the bottom 54 of the fan. When a single shroud is connected to every other blade stage 58/62 or 60/64, the intermediate blade stages 60/64 or 58/62 may have respective shrouds 66.

In another embodiment (not shown in detail) in which the fan 24 has multiple counter-rotating blade stages 56, adjacent stages 58/60, 60/62, 62/64 are linked to and driven by different electrical channels. The different electrical channels for adjacent blade stages 58/60, 60/62, 62/64 produce various electromagnetic fields to drive the adjacent stages in opposite directions. For example, every other blade stage 58/62 or 60/64 may be linked to a first group of electrical channels 72 while the blade stages 60/64 or 58/62 between them are linked to a second group of channels producing different electromagnetic fields than the first group of channels.

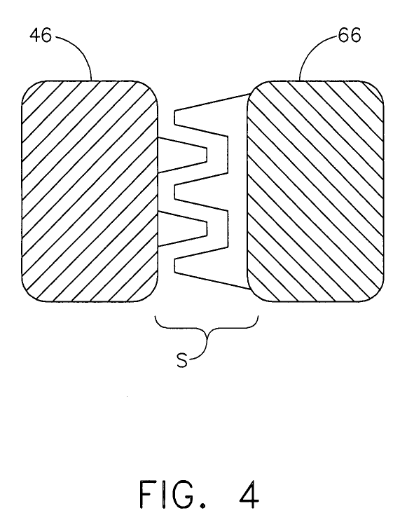

The fan 24 may include a plurality of magnets 78 connected to the blades 40 adjacent the blade tips 44. Magnets 78 do not need to be connected to blades 40 of fan blade stages 60, 64 or 58, 62 that are mechanically linked and fully driven by adjacent blade stages 58, 62 or 60, 64. Various types of magnets 78 and configurations of magnets may be connected to the blades 40 without departing from the scope of the present invention. For example, it is contemplated that, electromagnets may be connected to the blades (not shown). As a further example, additional electric wires 70 connected to the delivery system 28 could be mounted on the blades 40. For embodiments having a shroud 66, the magnets 78 may be mounted on or positioned in the shroud 66. In one embodiment, each magnet 78 is replaced by a conventional Halbach magnet array (not shown in detail). Thus, a Halbach magnetic array may be positioned adjacent each blade tip 44. A Halbach magnetic array is a configuration of at least five permanent magnets arranged adjacent each other with their polarities aligned in particular various directions so that resulting magnetic fields of the array are very strong on a front side of the array and substantially zero or cancelled out on a back side of the array. The resulting magnetic field of the array, from its front side, is much stronger than the overall field of any of the individual magnets constituting the array. As shown in FIG. 4, in an embodiment of the present invention including a shroud 66 and in which the electric wires 70 are positioned within the housing 46 or behind the wall “W” (shown in FIG. 3), the housing and the shroud may include structures “S” having corresponding shapes. The structures “S” may include wires 70 and/or magnets 78. The corresponding structures “S” align the housing 46 and shroud 66 and improve fan efficiency by improving the magnetic connection between the wires 70 and magnets 78.

In one embodiment, a single permanent magnet 78 is arranged adjacent each blade tip 44. The magnets 78 may be arranged so poles of adjacent magnets are pointing in opposite directions. For example, when a first magnet 80 of the plurality of magnets 78 has its north pole directed radially outward (therefore to be referred to as a “northern oriented magnet”), each adjacent magnet 82 may be oriented with its south pole directed radially outward (therefore to be referred to as a “southern oriented magnet”).

The blades 40 and magnets 78 rotate with respect to the housing 46 and are analogous to a rotor or armature of traditional electric motors. When current is transmitted through the channel 72, the magnets 78 are attracted and/or repelled by the electromagnetic fields created by the current. For example, as shown in FIG. 5, each northern oriented magnet 80 will be attracted to a magnetic flux created by the first adjacent channel portion 74 having a current passing through it so as to form a southern or negative electromagnetic field and repelled by a magnetic flux created by a second adjacent channel portion 76 forming a northern or positive electromagnetic field as a result of the direction of the current passing through it. Conversely, each southern oriented magnet 82 will be repelled by the magnetic flux created by the southern electromagnetic field formed by the first channel portion 74 and attracted to the magnetic flux created by the northern field formed by the other adjacent channel portion 76. The attractions and repulsions between the permanent magnets 78 and the electromagnetic fields formed by the channel 72 cause the magnets, blades 40 and hub 38 to rotate together with respect to the stationary housing 46.

The motor may be an alternating current motor. That is, the current flowing through the channel 72 may change directions continuously or intermittently to change the magnetic fields created by the channel. A strength of the current and a frequency at which the current is changed may vary to selectively increase or decrease the speed of the fan 24. In the alternating current embodiments, after the northern oriented magnets 80 have been attracted to the southern electromagnetic field of the first adjacent channel portions 74 and repelled by the northern fields of the second adjacent channel portions 76 and the southern oriented magnets 82 have been repelled by the southern electromagnetic field formed by the first adjacent channel portions and attracted to the northern fields of the second adjacent channel portions, the direction of current flowing through the channel 72 may be switched. When the current direction is switched, electromagnetic fields formed in the various portions of the channel 74, 76 will switch. Therefore, the channel portions 74, 76 that attracted a magnet 80, 82 towards them will change polarities to push those magnets 80, 82 past them and the channel portions 76, 74 that pushed magnets 82, 80 away from them will change polarities to attract the magnets 80, 82 coming towards them. For example, after being attracted to an initial southern electromagnetic field formed by the first channel portion 74 and repelled by an initial northern field formed by the second channel portion 76, the northern oriented magnet 80 will then become repelled by the new northern field of that first channel portion 74 and attracted to the new southern field formed by the next second channel portion 76 that the northern magnet approaches as the northern magnet moves circumferentially with respect to the channel 72 and housing 46. The attractions and repulsions between the magnets 78 and the electromagnetic fields are timed to cause blade 40 rotation. The rotating blades 40 pull air into the top 52 of the fan 24, compress the air, and direct the air to exit the aircraft 10 from the bottom 54 of the fan to produce vertical thrust. Because the electric fan 24 of aircraft 10 according to the present invention forces ambient air out of the bottom of the fan in front of the center of gravity “C” of the aircraft instead of hot exhaust, aircraft according to the present invention are safer and less harmful to take-off and landing surfaces.

The aircraft 10 may also include a fan cover 84 connected to the airframe 12 adjacent the top 50 of the fan housing 46. The cover 84 may be adjustable between a closed position, as shown in FIG. 2 by dashed lines, and an open position, as shown by solid lines in FIG. 2. When the cover 84 is open, air can enter the fan 24 from above the aircraft 10 and when the cover is closed, air is generally blocked from entering the fan from above the aircraft. The cover 84 facilitates fan 24 operation by directing or scooping air into the fan. For example, during initial take-off or when transitioning from forward flight to vertical flight, the cover may direct ambient air into the fan 24. The more air volume entering the fan 24, the more vertical thrust the fan can produce.

The aircraft 10 may further include a plurality of vanes 86 pivotally connected to the bottom 54 of the fan 24, such as adjacent the bottom of the hub 38. The vanes 86 would not rotate with the hub 38. Although the fan 24 may include other number of vanes 86 without departing from the scope of the present invention, in one embodiment the fan includes between about two and about six vanes. Each vane 86 is adjustable between a generally vertical position, as shown by solid lines in FIG. 2, in which the vane is substantially clear of a path of air exiting the fan 24, and a pivoted position, as shown by dashed lines in FIG. 2, in which the vane deflects air exiting the fan. As will be appreciated by those skilled in the art, by selectively deflecting air exiting the fan 24, aircraft 10 yaw and/or roll can be controlled during operation of the aircraft.

Operating the aircraft 10 includes directing high-pressure exhaust produced by the power plant 20 to exit the aircraft through the aft nozzle 22 between about horizontally rearward and about vertically downward. Aircraft 10 according to the present invention can safely and efficiently take-off and land vertically or using a short runway. For vertical flight, the aft nozzle 22 is adjusted to direct the power plant 20 exhaust downward, the fan cover 84 is opened, and the fan operates to provide balanced vertical thrust forward and rearward of the center of gravity “C”. For forward flight, the nozzle 22 is adjusted to direct the engine exhaust horizontally rearward, the fan cover 84 is closed, and the vertical fan 24 is not operated. The aircraft 10 can also transition from a vertical flight mode to a forward flight mode or from the forward flight mode to the vertical flight mode by flying in transition or intermediate flight modes by selectively positioning the fan cover 84 and the vanes 86 and selectively operating the power plant 20 and the electric fan 24. As described above, the vanes 86, particularly, may be adjusted to change aircraft yaw and/or aircraft pitch during flight. Adjustment of aircraft components (e.g., power plant 20, aft nozzle 22, electricity source 26, delivery system 28, and fan 24 including the cover 84 and vanes 86) can be selectively performed manually and/or automatically to accomplish desired flight or maneuvers. For example, in response to a user input to transition from forward flight to vertical flight for landing or to change aircraft pitch or yaw, a flight controller (not shown), such as a computerized controller, could automatically adjust the aircraft components (e.g., power plant 20, aft nozzle, 22, electricity source 26, delivery system 28, and fan 24 including the cover 84 and vanes 86) as appropriate to accomplish the flight or maneuvers.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

1. (canceled)

2. The aerospace vehicle of claim 3, further comprising multiple paths for said electric current to flow between the generator and the current channels; and a switch for controlling which path the current will flow along during operation of the lift fan.

3. The aerospace vehicle of claim 21, further comprising an electrical generator operatively connected to the propulsion engine for supplying electric current to the current channels during operation of the lift fan.

4. The aerospace vehicle of claim 21, wherein said plurality of magnets includes a Halbach magnet array positioned adjacent each blade tip.

5-6. (canceled)

7. The aerospace vehicle of claim 21, further comprising a plurality of vanes pivotally connected to a bottom of the lift fan wherein each vane is adjustable between a generally vertical position in which the vane is substantially clear of a path of air exiting the fan and a pivoted position in which the vane deflects air exiting the fan for controlling at least one of yaw and roll of the vehicle.

8. The aerospace vehicle of claim 21, further comprising an adjustable nozzle for the propulsion engine, wherein the aerospace vehicle has a vertical flight mode in which said fan operates to provide substantially vertical thrust and said nozzle is adjusted to direct propulsion engine exhaust downward to provide substantially vertical thrust and a forward flight mode wherein the fan is inoperative and the nozzle is adjusted to direct the exhaust about horizontally rearward.

9. The aerospace vehicle of claim 21, further comprising a fan cover for fan and adjustable between a closed position in which the cover generally blocks air from entering the fan from above the aerospace vehicle and an open position in which air can enter the fan from above the aerospace vehicle.

10-16. (canceled)

17. A method of flying an aircraft including an airframe, a power plant mounted on the airframe, an electricity source mounted on the airframe, and a vertical fan mounted on said airframe in electric communication with the electricity source, the fan including a rotor hub and a plurality of blades extending radially outward from the hub, said method comprising:
directing high-pressure exhaust produced by the power plant to exit the aircraft at an angle between about horizontally rearward and about vertically downward; and
selectively operating the fan using an electric current from the source of electricity to provide upward thrusts, including creating electromagnetic fields about tips of the blades to cause attractions and repulsions with magnets at tips of the blades, the attractions and repulsions causing the fan to rotate and provide the upward thrust.

18-20. (canceled)

21. An aerospace vehicle comprising:
a fuselage;
a propulsion engine at an aft end of the fuselage; and
an electrically-driven lift fan attached to the fuselage ahead of the propulsion engine, including:
a fan stage including a plurality of rotor blades;
a tip shroud surrounding the fan stage and connected to tips of the fan blades, the tip shroud including a plurality of magnets; and
a housing surrounding the tip shroud, the housing including current channels for generating electromagnetic fields;
wherein attractions and repulsions between the electromagnetic fields and the magnets causes the rotor blades to rotate.

22. The aerospace vehicle of claim 21, wherein the lift fan further includes at least one additional fan stage, each additional fan stage including a plurality of rotor blades, a tip shroud including a plurality of magnets, and a housing including a current channel.

23. The aerospace vehicle of claim 21, wherein the fan stage further includes a rotor hub, each blade extending radially outward from its base to its tip.
